(19) United States
(12) Patent Application Publication
(10) Pub. No.: US 2006/0282545 A1
(43) Pub. Date: Dec. 14, 2006

(54) Method and apparatus for application or protocol version negotiation

(76) Inventors: John Elliot Arwe, Poughkeepsie, NY (US); John Alan Bivens, Ossining, NY (US); Garth Richard Conrad, Los Angeles, CA (US); Constantinos Kassimis, Cary, NC (US); Gary Owen McAfee, Raleigh, NC (US); Gerald X. McKenna, Mebane, NC (US)

Correspondence Address: George A. Willinghan, III;August Law Group, LLC, P.O. Box 19080, Baltimore, MD, 21284-9080, US

(21) Appl. No.: 11/150,352

(22) Filed: Jun. 11, 2005

(51) Int. Cl. G06F 15/16

(52) U.S. Cl. 709/237

(57) ABSTRACT

A method for version negotiation between two entities is provided. Described in the context of communication protocol negotiation, an initiating entity proposes an initial communication protocol version to a receiving entity. In response, the receiving entity accepts the protocol version if it is within the range of its supported versions or proposes an alternative protocol version selecting to be either the highest or lowest protocol version supported by the receiving entity. This allows the receiving entity to successfully limit the number of protocol versions it supports and to communicate this restriction in any protocol setting to the initiating entity. The initiating entity then accepts the proposed alternative protocol version. If version negotiation is successful, either the accepted initial version or the accepted alternative version of the communication protocol is used for the duration of the communication session between the initiating entity and the receiving entity.

### FIELD OF THE INVENTION

The present invention is directed to the field of computer component interaction including communication protocols and function calls.

### BACKGROUND OF THE INVENTION

In order for two components to successfully interact, these components need to agree on a form and version for the interaction. This process is best illustrated by analyzing a network protocol based interaction between two components. In order for the two components to communicate in a network environment, these components need to use the same general communication protocol and in particular the same version of that communication protocol. Therefore, an initial requirement in establishing a communication session between two components is the verification and negotiation of a commonly accepted and supported communication protocol version.

In an attempt to alleviate these differences, some protocols incorporate a basic protocol version negotiation. These basic negotiations involve a first component starting the interaction using a selected protocol version and a second component responding to this interaction using the same version level or proposing a higher level by responding using a higher version message. If the first component supports the second component's proposed higher version, the first component proceeds using this higher version. If the first component cannot support the version proposed by the second component, communication between the two components is halted or indeterminate behavior results. These simple negotiations provide for version negotiation in a single direction, upwards to higher versions of the protocol. However, these negotiations do not provide for the components to negotiate downward to lower versions of the protocol.

A few protocols have more complex protocol negotiation stages. The Secure Socket Layer and Transport Layer Security protocols (SSL/TLS) are network-related protocols that negotiate cipher suites for authentication and encryption before any data is exchanged. SSL and TLS accomplish the negotiation of cipher suites by the interaction initiating component advertising or broadcasting all of the cipher suites that it supports during a negotiation stage. The interaction receiving component compares the list of supported cipher suites from the initiating component to a list of cipher suites supported by the receiving component. Based upon this comparison, the receiving component selects the cipher suite common to both lists and having the highest level of security. That method, however, cannot be applied to existing communication protocols without major structural and behavioral changes to these protocols. In addition, the negotiation used by SSL/TLS requires the advertisement of all supported protocol versions, which is often unnecessary because the secondary entities will typically only select the highest.

U.S. Pat. No. 4,558,413 discloses methods for version control and automatic software management. The disclosed system attempts to manage software upgrades by automatically collecting and recompiling updated versions of component software objects using a network connection. The version control and management system manages new edits to software programming files to provide software developers with a complex application compilation tool that provides an automated process of compiling the latest version of a particular application. The disclosed system does not address the situation of version negotiation between two components.

U.S. Pat. Nos. 5,848,064 and 6,031,830 disclose methods for providing software upgrades from a host computer to one or more mobile computers in a wireless environment. As disclosed, each mobile device contacts a host computer across a wireless network, and a comparison is made of the version of the operating software being run on the mobile device versus the current version of that software stored on the host computer. If the mobile unit or host determines that the software version being run on the mobile unit is different than the version stored on the host, then the software version stored on the host is downloaded to the mobile device. Although this provides for operating system upgrades, this method also fails to address the situation of version negotiation between two components.

U.S. Pat. No. 6,757,893 is directed to a version control system for software code. The disclosed system assists software development groups that develop large applications by storing modified lines of code under multiple versions. Therefore, the multiple versions are available to the software developers to use and to edit. The system, however, does not provide for any type of version verification or upgrading but instead stores or maintains files containing all created versions of a given line or lines of code. Again, this method also fails to address the situation of version negotiation between two components.

Thus, a method for verification, negotiation and selection of communication protocol versions between two entities is desired that facilitates the negotiation of both higher and lower protocol versions. In addition, the negotiation method would be able to fit within the existing structural framework of existing communication protocols without significant structural changes to those protocols.

### SUMMARY OF THE INVENTION

The present invention addresses the process of version negotiation and the weakness of ambiguous compatibility issues that exist in traditional version negotiation stages of many component interactions. Exemplary methods in accordance with the present invention are applied in all forms of component interactions including network protocol based interactions. In the context of network communication protocols, version compatibility and negotiation problems are resolved by introducing a negotiation mechanism for the entity that is initially contacted using the communication protocol, i.e. the “server”, to limit the number of protocol versions it supports and to communicate this limitation or restriction in any protocol setting. The negotiation mechanism is structured for use in existing protocols without the need for changing the structure of the protocol itself. Methods in accordance with the present invention only modify the behavior of protocol negotiation. In addition to being used to modify existing protocol negotiation behavior, negotiation mechanisms in accordance with the present invention are integrated into the design of new protocols to provide for substantially complete version-negotiated communication.

Methods and systems for version negotiation in accordance with exemplary embodiments of the present invention communicate upward and backward compatibility for new and existing protocols. The version negotiation stage within the protocol is augmented by adding the ability for the entity that is initially contacted, i.e. the server, to respond to the initiating entity both lower and upper bounds for protocol versions during the process of establishing the interaction between the two entities. Upon receiving the upper and lower bound information, the initiating entity adjusts its version accordingly or if necessary, terminates the interaction.

Protocol version negotiation can be accomplished during a dedicated version negotiation stage or during the normal flow of data between two entities. Exemplary methods in accordance with the present invention work with either structure of version negotiation, because no structural change to the actual protocol is required. Therefore, applications can utilize methods in accordance with the present invention in existing protocols. The present invention provides for a less ambiguous protocol version-negotiation for all protocols and adds the benefit of clear and communicated version control to the entity that is initially contacted. Therefore, contacted entities do not need to carry functionality for a large number of protocol versions.

### BRIEF DESCRIPTION OF THE DRAWINGS

FIG. 1 is a flow chart illustrating an exemplary embodiment of a method for negotiating protocol versions in accordance with the present invention.

### DETAILED DESCRIPTION

The present invention provides a mechanism for performing version negotiation between two entities. In the embodiment as illustrated, these entities communicate across a distributed environment using a common communication protocol. However, methods and systems in accordance with the present invention can be applied to any type of interaction among components, for example function calls. As used herein, communication is the process of exchanging information using a common system of rules or symbols. A protocol is a convention or standard that controls or enables the connection, communication and data transfer between two computing endpoints or entities. These protocols are implemented by hardware, software and combinations of hardware and software and are generally used in real-time communications. A given communication protocol or network protocol is the specification of a set of rules for that particular type of communication. Over time, different versions of the software embodying a given communication protocol are developed and distributed. The first or older versions are assigned lower numbers and are referred to as lower versions. Later or newer versions are assigned higher numbers and are referred to as higher versions. In order for two components to communicate using a common communication protocol, the two components need to run compatible versions of that communication protocol. Therefore, when a first or initiating entity contacts a second entity using a particular communication protocol, the versions of the communication protocol being run by each entity are verified and synchronized to facilitate proper communication.

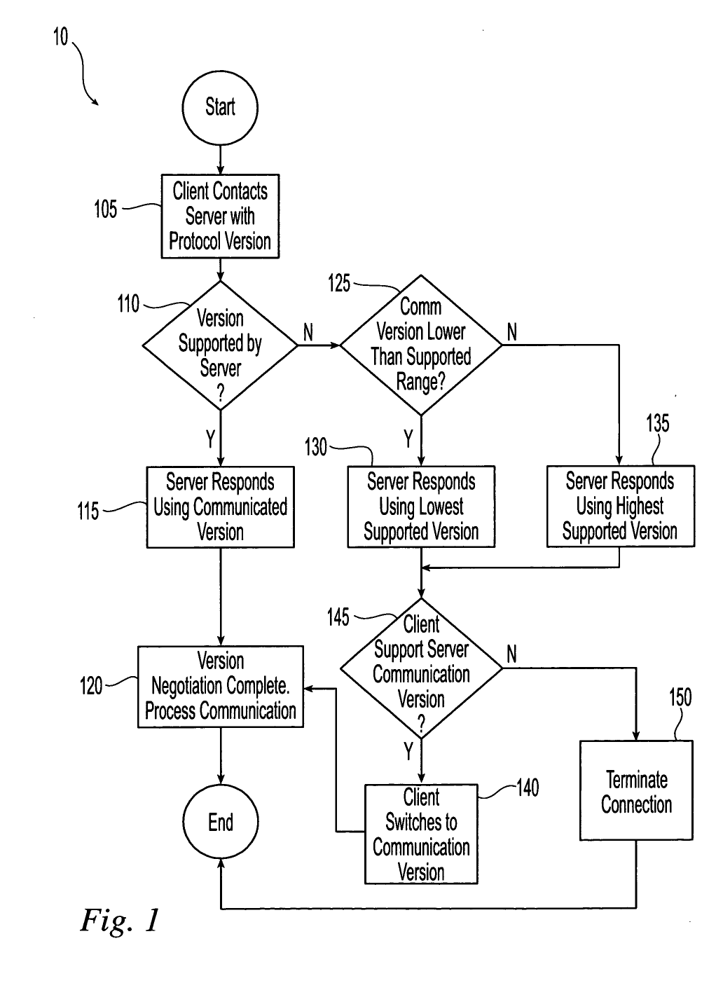

Referring to FIG. 1, an exemplary embodiment of a method for version verification, negotiation and synchronization 10 between two entities in accordance with the present invention is illustrated. As illustrated, the method for version verification is applied to a client-server distributed system. However, methods in accordance with the present invention are not limited to client-server distributed systems and can be implemented over any networked arrangement of computers or in any environment requiring communication or interfacing between two entities or components. Suitable entities include any entity or device that communicates in a structured manner, for example components within a single application, the layers of components within an application or components or devices that communicate across networks including local and wide area networks. In one embodiment, the entities are disposed in a distributed environment such as a network.

As illustrated, the process of version negotiation begins when a first component or initiating entity, e.g. the client, contacts a second component or the receiving entity to be contacted, e.g. the server, and proposes an initial communication protocol version to be used during a communication session between the initiating entity and the receiving entity. As illustrated, the initial communication protocol version is proposed by sending a message using the client's desired protocol version 105. Suitable communication or network protocols include, but are not limited to HyperText Transfer Protocol (HTTP), Simple Mail Transfer Protocol (SMTP), File Transfer Protocol (FTP), Secure Shell (SSH), Internet Relay Chat (IRC), Simple Network Management Protocol (SNMP), Session Initiation Protocol (SIP), Real-time Transport Protocol (RTP), Transmission Control Protocol (TCP), User Datagram Protocol (UDP), Internet Control Message Protocol (ICMP), Stream Control Transmission Protocol (SCTP), Datagram Congestion Control Protocol (DCCP), Address Resolution Protocol (ARP), Internet Protocol (IP), Ethernet, Wi-Fi, Token Ring, fiber-distributed data interface (FDDI) and protocol suites and stacks containing one or more of these protocols. In one embodiment, the initiating entity proposes the highest communication protocol version that it is capable of supporting.

Depending on the structure of the communication protocol being used by the client, protocol version negotiation occurs during a dedicated version negotiation phase of the protocol or during the general exchange of messages provided by the protocol. Regardless of when version negotiation occurs, messages or data exchanged between the client and the server during the initial contact between client and server 105 contain an identification of the communication protocol and the version of the communication protocol as selected by the initiating entity. In one embodiment, the exchanged messages include a distinct data field containing an express identification of the desired communication protocol and version. In another embodiment, the current protocol version is associated with or embedded in the exchanged messages such that the version is discernable by the server when processing the exchanged messages. Suitable methods and arrangements for including the current protocol version in a dedicated field or embedded in the exchanged messages are known and available in the art.

In general for a given communication protocol, the server is capable of supporting a range of versions of that communication protocol. Therefore, the server reads the communication protocol and version and determines if that version is supported 110, i.e. if the communicated version is within the range of versions supported by the server. If the communication protocol version is supported by the server, the server accepts the initially proposed communication protocol version and responds to the client contact using the same communication protocol version 115. At this point the process of negotiating communication protocol versions between the client and server is complete, and communications between the client and server are processed accordingly 120. Both the initiating entity and the receiving entity use the initially proposed communication protocol version for the duration of the communication session between the initiating entity and the receiving entity.

If the communicated version is not within the range of versions supported by the receiving entity, then the receiving entity can respond to the initiating entity by proposing an alternative communication protocol version. In one embodiment, the communicated version is checked to see if this version is an earlier or lower version of the communication protocol 125. If the client-proposed version is lower than any version supported by the server, the server responds to the client using a message containing the lowest version supported by the server 130. Again, this lowest supported version can be communicated in a separate field or embedded in the message. Alternatively, if the client-proposed version is not lower than the range of versions supported by the server, then the client-proposed version is higher or newer than the highest version supported by the server, and the server responds to the client using a message containing the highest version supported by the server 135, either in a separate field or embedded in the message.

The client receives the response message from the server, interprets the communicated version and checks to see if the client supports the communication protocol version sent by the server 145. If the client supports the server-proposed version of the communication protocol, the client accepts the alternative communication protocol version and switches to the version proposed by the server 140, which is either the highest or lowest communication protocol version supported by the server, for subsequent messages exchanged between the initiating entity and the receiving entity. The client and server use the alternative server-proposed version for the duration of the communication session 120. Therefore, the client proposes an initial version for the communication protocol, and in response, the server can propose alternative upper or lower bounds for the version level. If the client does not support the server-proposed communication protocol version, the connection between the initiating entity or client and the receiving entity or server is terminated 150, and the communication session ends.

In one embodiment, the client or initiating entity begins the communication session using the highest protocol version that is supported by the initiating entity. In accordance with exemplary methods and systems of the present invention, by initiating communication sessions using the highest supported protocol version, the level or protocol version used by the initiating entity and the receiving entity converges to the highest supported protocol common to both entities.

The present invention is also directed to a machine or computer readable medium containing a machine or computer executable code that when read by a machine or computer causes the machine or computer to perform exemplary methods for communicating, negotiating and adjusting communication protocol versions in accordance with the present invention and to the machine or computer executable code itself. The computer executable code can be stored on any suitable storage medium or database, including databases disposed within, in communication with and accessible by the communicating entities and computer networks utilized by systems in accordance with the present invention. Exemplary storage media include but are not limited to magnetic media, optical media, floppy disks, compact discs and DVD's, jump drives, hard drives and combinations thereof. In addition, the computer executable code can be executed on any suitable hardware platform as are known and available in the art.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A method for negotiating communication protocol versions between two entities, the method comprising:
proposing an initial communication protocol version from an initiating entity to a receiving entity;
accepting the initial communication protocol version at the receiving entity if the proposed initial communication protocol version is supported by the receiving entity;
proposing an alternative communication protocol version from the receiving entity to the initiating entity if the receiving entity does not support the proposed initial communication protocol version, wherein the alternative communication protocol version comprises:
a highest communication protocol version supported by the receiving entity if the proposed initial communication protocol version is higher than the highest supported communication protocol version; and
a lowest communication protocol version supported by the receiving entity if the proposed initial communication version is lower than the lowest supported communication protocol version; and
accepting the alternative communication protocol version at the initiating entity if the proposed alternative communication protocol version is supported by the initiating entity.

2. The method of claim 1, wherein the step of proposing the initial communication protocol version comprises proposing the highest communication protocol version supported by the initiating entity.

3. The method of claim 1, wherein the step of proposing the initial communication protocol version comprises sending a message from the initiating entity to the receiving entity containing an identification of the initial communication protocol version.

4. The method of claim 3, wherein the step of sending the message further comprises placing the identification of the initial communication protocol in a distinct message field.

5. The method of claim 3, wherein the step of sending the message further comprises embedding the initial communication protocol version in the message such that the initial communication protocol version is discernable by the receiving entity upon reading the message.

6. The method of claim 1, wherein the initiating entity is a client and the receiving entity is a server in communication with the client across one or more networks.

7. The method of claim 1, wherein the step of accepting the initial communication protocol version comprises determining if the proposed initial communication protocol version is within a range of versions supported by the receiving entity.

8. The method of claim 1, wherein the step of accepting the proposed alternative communication protocol version comprises switching to the proposed alternative communication protocol version at the initiating entity for subsequently exchanged messages.

9. The method of claim 1, further comprising using either the accepted initial communication protocol version or the accepted alternative communication protocol version during a communication session between the initiating entity and the receiving entity.

10. A computer readable medium containing a computer executable code that when read by a computer causes the computer to perform a method for negotiating communication protocol versions between two entities, the method comprising:
proposing an initial communication protocol version from an initiating entity to a receiving entity;
accepting the initial communication protocol version at the receiving entity if the proposed initial communication protocol version is supported by the receiving entity;
proposing an alternative communication protocol version from the receiving entity to the initiating entity if the receiving entity does not support the proposed initial communication protocol version, wherein the alternative communication protocol version comprises:
a highest communication protocol version supported by the receiving entity if the proposed initial communication protocol version is higher than the highest supported communication protocol version; and
a lowest communication protocol version supported by the receiving entity if the proposed initial communication protocol version is lower than the lowest supported communication protocol version; and
accepting the alternative communication protocol version at the initiating entity if the proposed alternative communication protocol version is supported by the initiating entity.

11. The computer readable medium of claim 10, wherein the step of proposing the initial communication protocol version comprises proposing the highest communication protocol version supported by the initiating entity.

12. The computer readable medium of claim 10, wherein the step of proposing the initial communication protocol version comprises sending a message from the initiating entity to the receiving entity containing an identification of the initial communication protocol version.

13. The computer readable medium of claim 12, wherein the step of sending the message further comprises placing the identification of the initial communication protocol in a distinct message field.

14. The computer readable medium of claim 12, wherein the step of sending the message further comprises embedding the initial communication protocol version in the message such that the initial communication protocol version is discernable by the receiving entity upon reading the message.

15. The computer readable medium of claim 10, wherein the initiating entity is a client and the receiving entity is a server in communication with the client across one or more networks.

16. The computer readable medium of claim 10, wherein the step of accepting the initial communication protocol version comprises determining if the proposed initial communication protocol version is within a range of versions supported by the receiving entity.

17. The computer readable medium of claim 10, wherein the step of proposing the alternative communication protocol version comprises.
proposing a highest communication protocol version supported by the receiving entity if the proposed initial communication version is higher than the highest supported communication protocol version; and
proposing a lowest communication protocol version supported by the receiving entity is the proposed initial communication version is lower than the lowest supported communication protocol version.

18. The computer readable medium of claim 10, wherein the step of accepting the proposed alternative communication protocol version comprises switching to the proposed alternative communication protocol version at the initiating entity for subsequently exchanged messages.

19. The computer readable medium of claim 10, further comprising using either the accepted initial communication protocol version or the accepted alternative communication protocol version during a communication session between the initiating entity and the receiving entity.
